(19) United States
(12) Patent Application Publication
(10) Pub. No.: US 2018/0371933 A1
(43) Pub. Date: Dec. 27, 2018

(54) OPTIMIZED ENGINE CONTROL WITH ELECTRIFIED INTAKE AND EXHAUST

(71) Applicant: EATON CORPORATION, Cleveland, OH (US)

(72) Inventors: Vasilios TSOURAPAS, Northville, MI (US); Sean Paul KEIDEL, Royal Oak, MI (US); Matthew James FORTINI, Livonia, MI (US)

(21) Appl. No.: 16/062,530

(22) PCT Filed: Dec. 14, 2016
(86) PCT No.: PCT/US2016/066636

§ 371 Date: Jun. 14, 2018

Related U.S. Application Data
(60) Provisional application No. 62/267,045, filed on Dec. 14, 2015.
(60) Provisional application No. 62/298,130, filed on Feb. 22, 2016.

(51) Int. Cl. F01D 15/10; F01N 5/04; F02B 33/38; F02B 39/10; F02B 41/10; F02B 39/16

(52) U.S. Cl. CPC F01D 15/10; F01N 5/04; F02B 39/16; F02B 39/10; F02B 41/10; F02B 33/38

(57) ABSTRACT

In one aspect, the teachings presented herein include a power generation system including: a power plant having an air intake and an exhaust outlet; a boost device in fluid communication with the power plant air intake, the boost device being for pressurizing air entering the power plant air intake; a waste heat recovery device in fluid communication with the power plant exhaust outlet, the waste heat recovery device being for recovering energy from exhaust from the power plant; a first motor/generator coupled to the boost device; a second motor/generator coupled to the waste heat recovery device; an energy storage device for storing energy generated by the first and second motor/generators and for delivering power to drive the first motor/generator; a controller for controlling the first and second motor/generators, wherein the controller is configured to control the level of power generated by the waste heat recovery device based on a state of charge of the energy storage device.

### CROSS-REFERENCE TO RELATED APPLICATIONS

This application is being filed on Dec. 14, 2016 as a PCT International Patent Application and claims the benefit of U.S. Patent Application Ser. No. 62/267,045, filed on Dec. 14, 2015, and claims the benefit of U.S. Patent Application Ser. No. 62/298,130, filed on Feb. 22, 2016, the disclosures of which are incorporated herein by reference in their entireties.

### GOVERNMENT LICENSE RIGHTS

This invention was made with government support under DE-EE0006844 awarded by the United States Department of Energy. The government has certain rights in the invention.

### TECHNICAL FIELD

This application relates to engine systems. More specifically, the application is directed to optimized control of waste heat recovery and pressure boosting systems associated with a power plant.

### BACKGROUND

In some power generation systems, devices are placed in the exhaust stream of a power plant to capture waste energy. Any rotating volumetric or centrifugal device aimed at recovering energy from an engine exhaust flow will incur engine backpressure while recovering energy. The backpressure in turn incurs engine pumping losses on the engine and affects negatively the engine breathing.

### SUMMARY

The proposed solution described herein aims at minimizing the incurred backpressure losses by dynamically adjusting the target amount of recovered energy depending on the energy needs of the overall system while taking into account the required energy for boosting the engine.

In one aspect, the teachings presented herein include a power generation system including: a power plant having an air intake and an exhaust outlet; a boost device in fluid communication with the power plant air intake, the boost device being for pressurizing air entering the power plant air intake; a waste heat recovery device in fluid communication with the power plant exhaust outlet, the waste heat recovery device being for recovering energy from exhaust from the power plant; a first motor/generator coupled to the boost device; a second motor/generator coupled to the waste heat recovery device; an energy storage device for storing energy generated by the first and second motor/generators and for delivering power to drive the first motor/generator; a controller for controlling the first and second motor/generators, wherein the controller is configured to control the level of power generated by the waste heat recovery device based on a state of charge of the energy storage device.

In one example, the controller includes a dynamic recovery factor defined as the ratio between the power generated by the waste heat recovery device at the second motor/generator and the power delivered to the first motor/generator to drive the boost device. The dynamic recovery factor can be set to equal a value of 1 when the state of charge of the energy storage device is at zero. The dynamic recovery factor can also be set to equal a value of 1 when the state of charge of the energy storage device is between zero and a predetermined setpoint. In one example, the dynamic recovery factor is decreased as the state of charge of the energy storage device increases beyond the predetermined setpoint.

A method for controlling a power generation system having an internal combustion engine, a supercharger, and a volumetric expander is also presented. The method can include the steps of: identifying a required first power value for driving a first motor/generator associated with the supercharger; determining a state of charge of a battery connected to the first motor/generator; and determining a second power value for a second motor/generator associated with the volumetric expander, the second power value being based on the battery state of charge. A dynamic recovery factor can be utilized in the method, as described above.

Additional objects and advantages will be set forth in part in the description which follows, and in part will be obvious from the description, or may be learned by practice of the teachings presented herein. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a schematic view of a power generation system, which is an example in accordance with aspects of the invention.

FIG. 2 is a graph showing a relationship between a dynamic recovery factor and a battery state of charge usable in controlling the power generation system shown in FIG. 1.

FIG. 3 is a schematic side view of an expander usable in the power generation system shown in FIG. 1.

FIG. 4 is a schematic perspective view of the expander shown in FIG. 3.

FIG. 5 is a schematic side view of a hybrid electric supercharger assembly usable in the power generation system shown in FIG. 1.

FIG. 6 is a representative graph showing engine thermal efficiency as a function of the pressure drop through the expander that is part of the power generation system shown in FIG. 1.

FIG. 7 is a representative graph showing expander efficiency as a function of the pressure drop through the expander that is part of the power generation system shown in FIG. 1.

FIG. 8 is a representative graph showing multiple component power curves as a function of the pressure drop through the expander that is part of the power generation system shown in FIG. 1.

FIG. 9 is a representative graph showing a brake specific fuel consumption curve as a function of the pressure drop through the expander that is part of the power generation system shown in FIG. 1.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

### General System Architecture

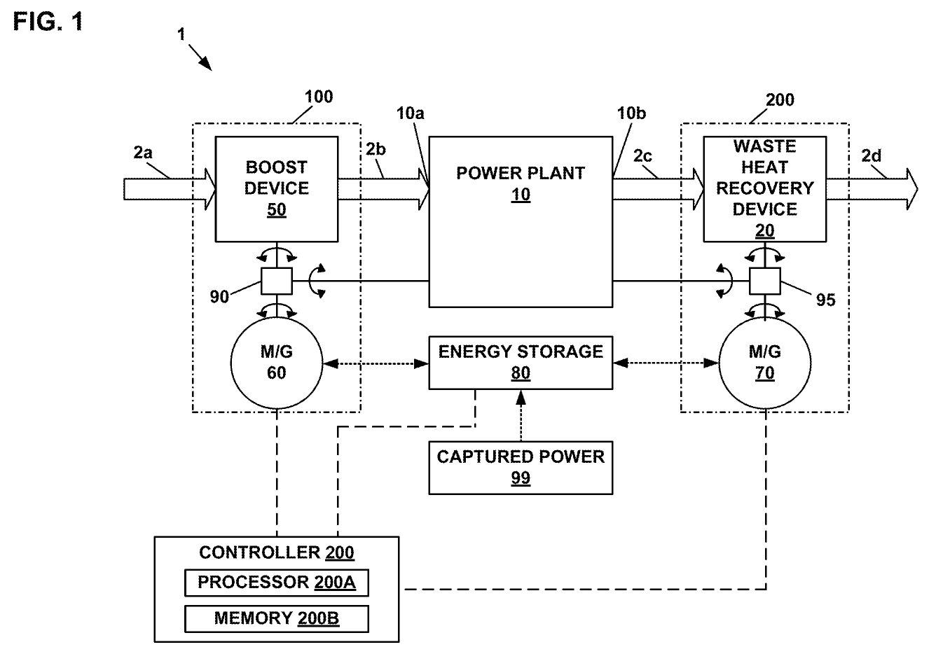

Referring to FIG. 1, a power generation system or engine system 1 is shown. In one aspect, the power generation system includes a power plant 10. The power generation system 1 can include a power plant 10, for example an internal combustion engine or a fuel cell. The power generation system 1 is also shown as being provided with a boost device 50 and a waste heat recovery device 20, both of which are discussed in further detail below. The boost device 50 receives an airstream 2a at atmospheric pressure and increased the pressure to create a pressurized airstream 2b which is delivered to an intake 10a of the power plant 10. The power plant 10 utilizes the airstream for combustion and exhausts an exhaust airstream 2c at an exhaust outlet 10b. The waste heat recovery device 20 receives the exhaust airstream 2c and removes at least some of the energy from the exhaust airstream 2c to create a reduced energy exhaust airstream 2d.

In one aspect, the boost device 50 can be driven by a motor/generator 60 via a power transmission link 90. The boost device 50 can also drive the motor/generator 60 to recapture power from the system. The power transmission link 90 can be configured in various ways. For example, the power transmission link 90 can be provided as a simple mechanical connection between a drive shaft of the motor/generator 60 and a drive shaft of the boost device 90. Alternatively, the power transmission link 90 can be provided as a planetary gear set to enable the boost device 50 to be selectively driven by either the motor/generator 60 or by the power plant 10 (e.g. via a front end accessory drive of the power plant 10). In one example, the boost device 50, the motor/generator 60, and the power transmission link 90 are packaged together to form a variable speed hybrid electric supercharger assembly 100. The assembly 100 may be provided with other components to enable various operational states, such as clutches and/or brakes. An electronic controller 200 can be utilized to operate the motor/generator 60 and the clutches/brakes, where provided.

In one aspect, the waste heat recovery device 20 drives a motor/generator 70 via a power transmission link 95. The motor/generator 70 can also drive the waste heat energy recovery device 20 to reduce pressure in the exhaust airstream 2c. The power transmission link 95 can be configured in various ways. For example, the power transmission link 95 can be provided as a simple mechanical connection between a drive shaft of the motor/generator 70 and a drive shaft of the waste heat recovery device 20. Alternatively, the power transmission link 95 can be provided as a planetary gear set to enable the waste heat recover device to selectively deliver power to either the motor/generator 70 or to the power plant 10 (e.g. via a front end accessory drive of the power plant 10). In one example, the energy recovery device 20, the motor/generator 70, and the power transmission link 95 are packaged together to form an energy recovery system 200. The energy recovery system 200 may be provided with other components to enable various operational states, such as clutches and/or brakes. The electronic controller 200 can be utilized to operate the motor/generator 70 and the clutches/brakes, where provided.

An energy storage device 80, such as a battery 80, may be placed in electrical communication with the motor/generator 60 and the motor/generator 70. This configuration allows for power generated by the waste heat recovery device 20 to be stored by the battery 80 and subsequently utilized by the motor generator 60 to drive the boost device 50. This configuration also allows for any power generated from energy recaptured by the boost device 50 to be stored by the battery 80 as well. Power captured by other sources 99 within the system, where present, can also be stored by the energy storage device 80. The electronic controller 200 is shown as being in communication with the energy storage device 80 such that the state of charge (SOC) of the energy storage device can be monitored.

### Waste Heat Recovery Device 20

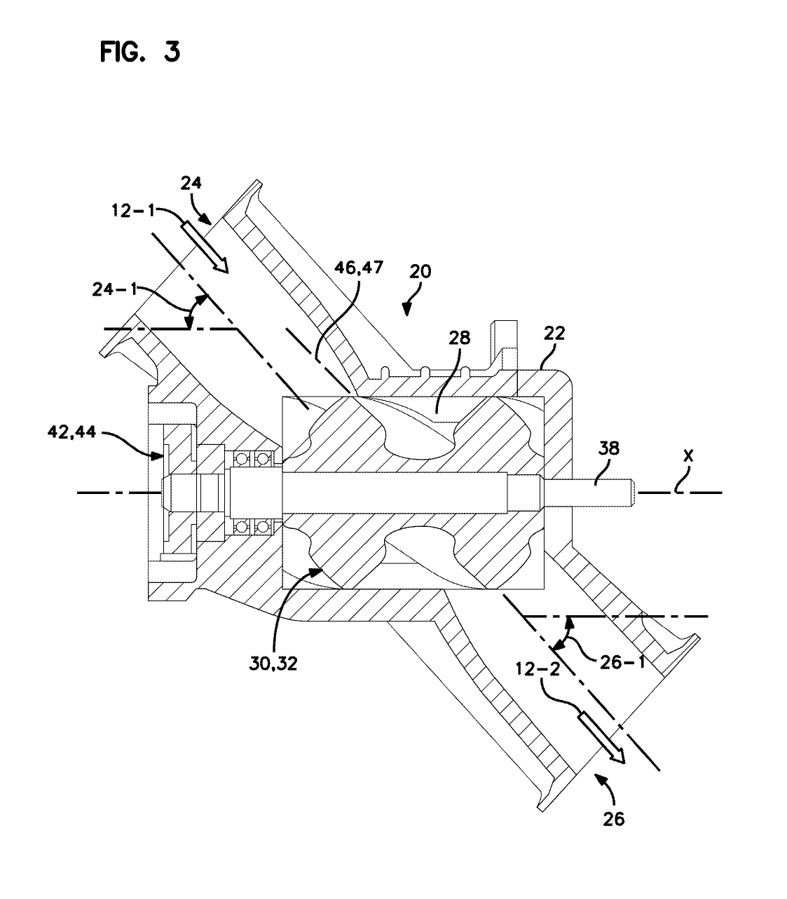

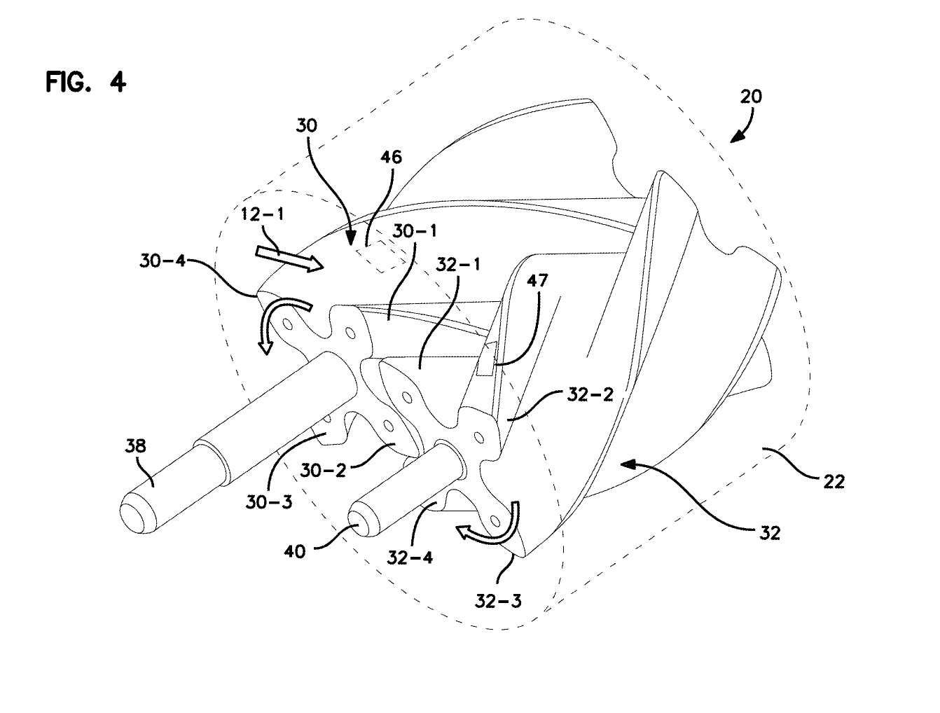

Referring to FIGS. 3 and 4, further aspects of the waste heat recovery device or expander 20 are shown. While some details of the expander 20 are discussed in this subsection, additional structural and operational aspects can be found in Patent Cooperation Treaty (PCT) International Publication Number WO 2014/144701 and in United States Patent Application Publication US 2014/0260245, the entireties of which are incorporated herein by reference.

In general, the volumetric energy recovery device or expander 20 relies upon the kinetic energy and static pressure of a working fluid to rotate an output shaft 38. The expander 20 may be an energy recovery device 20 wherein the working fluid 12-1 is the direct engine exhaust from the engine. In such instances, device 20 may be referred to as an expander or expander, as so presented in the following paragraphs.

With continued reference to FIGS. 3 and 4, it can be seen that the expander 20 has a housing 22 with a fluid inlet 24 and a fluid outlet 26 through which the working fluid 12-1 undergoes a pressure drop to transfer energy to the output shaft 38. The output shaft 38 is driven by synchronously connected first and second interleaved counter-rotating rotors 30, 32 which are disposed in a cavity 28 of the housing 22. Each of the rotors 30, 32 has lobes that are twisted or helically disposed along the length of the rotors 30, 32. Upon rotation of the rotors 30, 32, the lobes at least partially seal the working fluid 12-1 against an interior side of the housing at which point expansion of the working fluid 12-1 only occurs to the extent allowed by leakage which represents and inefficiency in the system. In contrast to some expanders that change the volume of the working fluid when the fluid is sealed, the volume defined between the lobes and the interior side of the housing 22 of device 20 is constant as the working fluid 12-1 traverses the length of the rotors 30, 32. Accordingly, the expander 20 may be referred to as a “volumetric device” as the sealed or partially sealed working fluid volume does not change.

In the particular example shown at FIGS. 11 and 12, the expander 20 inlets and outlets are configured for use with a relatively low pressure working fluid, such as exhaust from an internal combustion engine or fuel cell. However, the following description is generally applicable for use with any type of a working fluid. The expander 20 includes a housing 22. As shown in FIG. 11, the housing 22 includes an inlet port 24 configured to admit relatively high-pressure working fluid 12-1 from the heat exchanger 18 (shown in FIG. 4). The housing 22 also includes an outlet port 26 configured to discharge working fluid 12-2 to the condenser 14 (shown in FIG. 4). It is noted that the working fluid discharging from the outlet 26 is at a relatively higher pressure than the pressure of the working fluid at the condenser 14.

As additionally shown in FIG. 4, each rotor 30, 32 has four lobes, 30-1, 30-2, 30-3, and 30-4 in the case of the rotor 30, and 32-1, 32-2, 32-3, and 32-4 in the case of the rotor 32. Although four lobes are shown for each rotor 30 and 32, each of the two rotors may have any number of lobes that is equal to or greater than two, as long as the number of lobes is the same for both rotors. Accordingly, when one lobe of the rotor 30, such as the lobe 30-1 is leading with respect to the inlet port 24, a lobe of the rotor 32, such as the lobe 30-2, is trailing with respect to the inlet port 24, and, therefore with respect to a stream of the high-pressure working fluid 12-1.

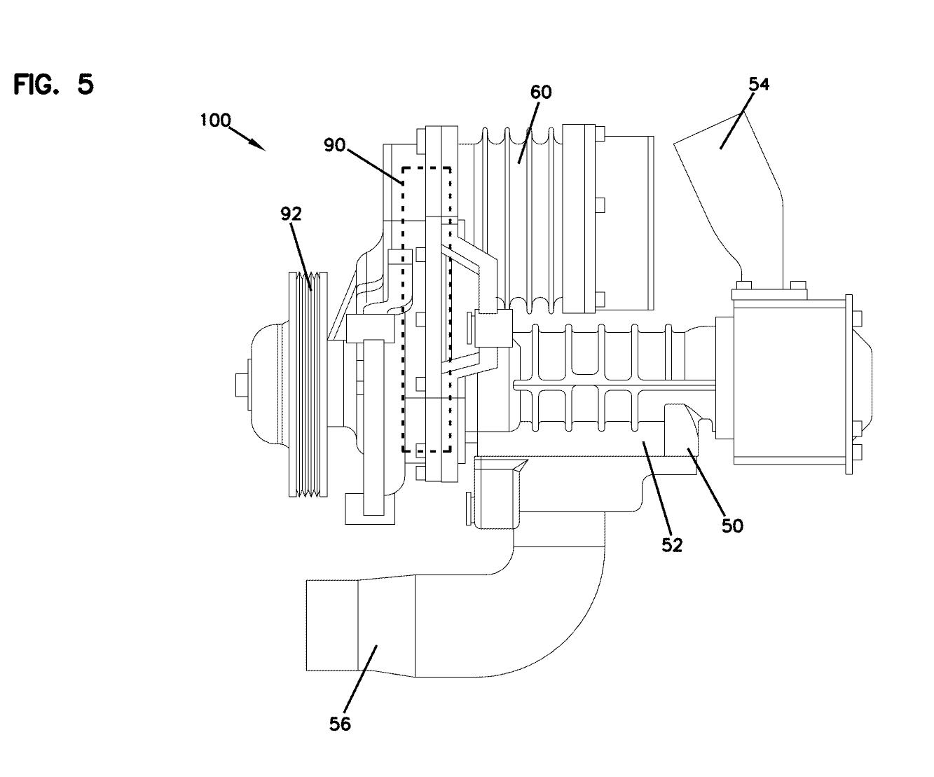

As shown, the first and second rotors 30 and 32 are fixed to respective rotor shafts, the first rotor being fixed to an output shaft 38 and the second rotor being fixed to a shaft 40. Each of the rotor shafts 38, 40 is mounted for rotation on a set of bearings (not shown) about an axis X1, X2, respectively. It is noted that axes X1 and X2 are generally parallel to each other. The first and second rotors 30 and 32 are interleaved and continuously meshed for unitary rotation with each other. With renewed reference to FIG. 5, the expander 20 also includes meshed timing gears 42 and 44, wherein the timing gear 42 is fixed for rotation with the rotor 30, while the timing gear 44 is fixed for rotation with the rotor 32. The timing gears 42, 44 are configured to retain specified position of the rotors 30, 32 and prevent contact between the rotors during operation of the expander 20.

The output shaft 38 is rotated by the working fluid 12 as the working fluid undergoes expansion from the relatively high-pressure working fluid 12-1 to the relatively low-pressure working fluid 12-2. As may additionally be seen in both FIGS. 5 and 6, the output shaft 38 extends beyond the boundary of the housing 22. Accordingly, the output shaft 38 is configured to capture the work or power generated by the expander 20 during the expansion of the working fluid 12 that takes place in the rotor cavity 28 between the inlet port 24 and the outlet port 26 and transfer such work as output torque from the expander 20. Although the output shaft 38 is shown as being operatively connected to the first rotor 30, in the alternative the output shaft 38 may be operatively connected to the second rotor 32.

In one aspect, the expander 20 can also be operated as a high volumetric efficiency positive displacement pump when driven by the motor/generator 70.

### Hybrid Electric Supercharger Assembly 100

Referring to FIG. 5, an example hybrid electric supercharger assembly 100 is shown. While some details of the hybrid electric supercharger assembly 100 are discussed in this subsection, additional structural and operational aspects can be found in Patent Cooperation Treaty (PCT) International Publication Number WO 2013/148205, the entirety of which is incorporated herein by reference.

In the example presented, the boost device 50 is a supercharger having a housing 52 with an air inlet 54 and an air outlet 56 through which the airflow stream 2 passes. In one example, the supercharger 50 houses a first rotor that can mesh with a second rotor, each of which having multiple lobes. The supercharger can boost the air pressure to force more air into engine cylinders of the power plant 10, thus increasing engine power to power a drive axle through a transmission in a vehicle application.

The supercharger 50 can be a fixed displacement supercharger, such as a Roots-type supercharger, that outputs a fixed volume of air per rotation. The increased air output then becomes pressurized when forced into a plenum. A Roots-type supercharger is a volumetric device, and therefore is not dependent on rotational speed in order to develop pressure. The volume of air delivered by the Roots-type supercharger per each rotation of the rotors is constant (i.e., does not vary with speed). A Roots-type supercharger can thus develop pressure at low engine and rotor speeds (where the supercharger is powered by the engine) because the Roots-type supercharger functions as a pump rather than as a compressor. Compression of the air delivered by the Roots-type supercharger 50 takes place downstream of the supercharger 50 by increasing the mass of air in the fixed volume engine plenum. Alternatively, the supercharger 50 can be a compressor, such as a centrifugal-type supercharger that compresses the air as it passes through the supercharger 50, but with the compression and thus the volume of air delivered to the throttle body and air pressure in the plenum being dependent on compressor speed.

As shown schematically, the assembly 100 is packaged with the power transmission link 90. In one example, the power transmission link 90 is a planetary gearing arrangement with a sun gear member, a ring gear member, and a carrier member that rotatably supports a set of pinion gears that can mesh with both the ring gear member and the sun gear member. The planetary gear set 90 can be a simple planetary gear set or a compound planetary gear set. In one configuration, a pulley 92 is coupled with the carrier member, a drive shaft for the supercharger 50 is coupled to the planet gears, and a drive shaft for the motor/generator 60 is coupled to the ring gear member. The pulley 92 can be connected to the engine crankshaft, for example via the front end accessory drive of the engine 10. As stated previously, the hybrid drive assembly 100 can also include various brakes and clutches to allow for the supercharger to be selectively driven by only the motor/generator 60, by only the power plant 10 via the pulley 59, or by both the motor/generator 60 and power plant 10. Clutches and/or brakes can also be utilized to allow the supercharger 50 to drive the motor/generator 60 without transmitting torque back into the power plant 10 (e.g. by holding the carrier gear member in a fixed position).

### Controller

Referring to back to FIG. 1, the electronic controller 200 is schematically shown as including a processor 200A and a non-transient storage medium or memory 200B, such as RAM, flash drive or a hard drive. Memory 200B is for storing executable code, the operating parameters, and potential inputs from an operator interface, while processor 200A is for executing the code. Electronic controller 200 is configured to be connected to a number of inputs and outputs that may be used for implementing the bypass operational modes. For example, the electronic controller 200 can receive information from a vehicle control area network (CAN) bus and information from sensors associated with the power generation system 1. For example, and as noted above, the energy storage device 80 can provide an input into the controller 200 as to the state of charge of the energy storage device 80 while the controller 200 can provide outputs to the motor/generators 60, 70 to drive or provide braking to the motor/generators 60, 70. One skilled in the art will understand that many other inputs and outputs can be provided to further implement the methods presented herein, particularly with respect to the boost device 50 and the waste heat recovery device 20.

### State of Charge Operation

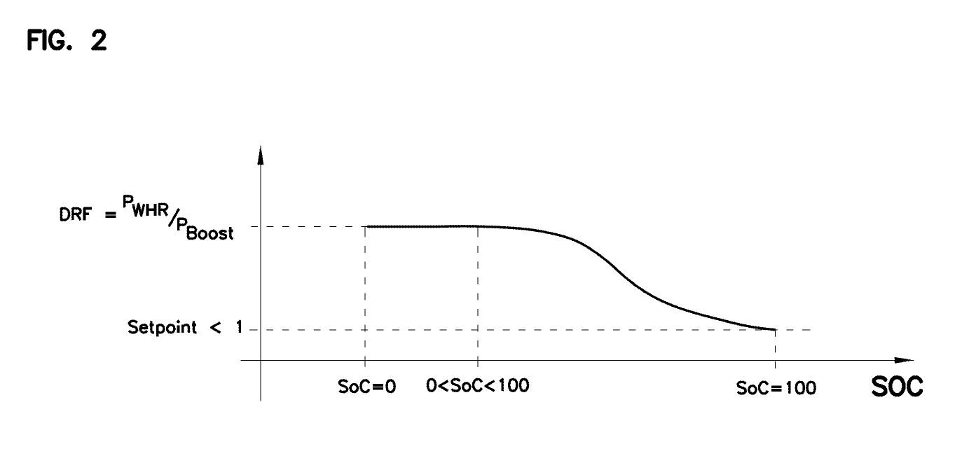

Referring to FIG. 2, a graphical depiction of the state of charge (SOC) of the energy storage device 80 with respect to a dynamic recovery factor DRF is depicted. As used herein, the dynamic recovery factor DRF represents the ratio of power P_{WHR} generated by the waste heat recovery device 20 at the motor/generator 70 that can be stored in the energy storage device 80 to the power P_{BOOST} that is required to be delivered to the boost device 50 via the motor/generator 50. The power P_{BOOST} is set at a level that ensures that the power plant 10 is operating optimally for each given fuel flow rate such that brake torque is maximized for a given fuel flow while taking into account parasitic losses.

The battery state of charge SOC is dependent on the energy used to boost (depletion) and the amount of energy recovered from brake energy and charging via the power captured by the waste heat recover device 20. When the amount of power P_{BOOST} required by the motor/generator 60 is equal to the P_{WHR} generated by the waste heat recovery device 20 at the motor/generator 70, the dynamic recovery factor DRF is equal to 1 and the battery state of charge SOC remains constant. The amount of power P_{WHR} that should be recovered can be controlled by setting the dynamic recovery factor DRF to an optimal setting where the additional backpressure caused by the waste heat recovery device 20 is justifiable.

The graph shown at FIG. 2 shows an example map showing how the dynamic recovery factor DRF can be dynamically adjusted over the drive cycle. Where the state of charge SOC is zero, meaning that the battery is completely depleted, and up to some predetermined state of charge SOC setpoint, the map indicates that the dynamic recovery factor DRF be set to equal 1, meaning that waster heat recovery generated power P_{WHR} is set to match the boost power P_{BOOST}. Where the state of charge SOC is higher than the preselected SOC setpoint, the amount of power generate power P_{WHR} is decreased relative to the boost power P_{BOOST} required as power captured from other sources (e.g. power generated and stored via the boost device 50 or from other sources 99) can be utilized to provide some or all of the boost power P_{BOOST}. Over time, as the state of charge SOC continues to increase from other captured power (i.e. power delivered to energy storage device 80 from sources other than from the waste heat recovery device 20 and motor/generator 70) the system (e.g. controller 200) will continually drop the dynamic recovery factor to a minimum value following the shape or profile of the curve shown at FIG. 2. In one example, the minimum value is zero. Where the energy storage device or battery 80 is being heavily used and the state of charge drops rapidly, the dynamic recovery factor DRF can be readily returned to a value of 1 in a worst case scenario.

It is noted that the curve shown in FIG. 2 can be stored as a data map in the controller 200, can be defined by as a formula such that the dynamic recovery factor DRF can be repeatedly calculated, or can be stored in some other way. Although a given shape or profile for the curve is shown at FIG. 2, it is noted that many variables can be utilized to determine an optimal shape or profile. Exemplary parameters are: the impact of backpressure on the engine torque output; driver aggressiveness (e.g. patternistic acceleration rate, frequency, etc.); drive cycle aggressiveness (e.g. highway driving vs. city driving); battery conditions, age of the battery, ambient temperature, discharging patterns; engine exhaust temperature and composition; engine operating temperature; and requests for passing/acceleration (e.g. engine throttle wide open). Other parameters may be utilized as well. The curve can be predefined at the factory and stored on the controller 200 as a static curve. The controller 200 can also store multiple sets of curves and can select different curves based on various parameters, such as those discussed above. The curve can also be adaptive in nature and refined over time as the vehicle controller “learns” the driver, conditions, and other aforementioned factors that impact operation.

### Backpressure Optimization Operation

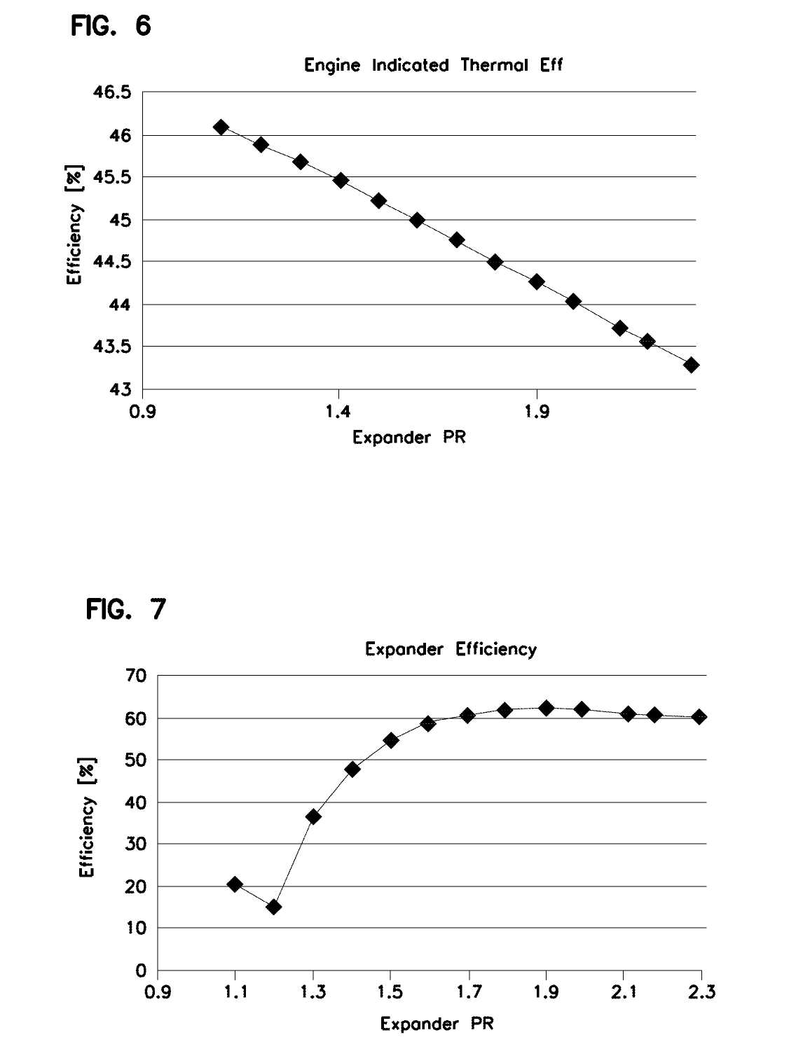

As discussed previously, the waste heat recovery device 20 generates power out of engine exhaust. Typically engine backpressure is increased in order for the device to generate more power, as can be observed at FIG. 6. However, engine backpressure has a negative impact on engine efficiency due to higher residuals. Conversely, the efficiency of the waste heat recovery device increases with pressure, as can be observed at FIG. 7. Given the above, it is advantageous to identify the optimum engine backpressure that maximizes the system efficiency (i.e. the minimum penalty on engine due to backpressure and maximum power generation from the waste heat recovery device).

Test and simulation results indicate that there is an optimum operating backpressure where the waste heat recovery device power generated is higher than the lost power from engine backpressure. This operating point can be identified during operation by taking into account the engine parameters as well as a waste heat recovery device operating map. It has been found that engine brake torque, pumping load, boosting power, combustion efficiency of the engine, and the waste heat recovery device efficiency are operating parameters that are useful in determining optimum backpressure.

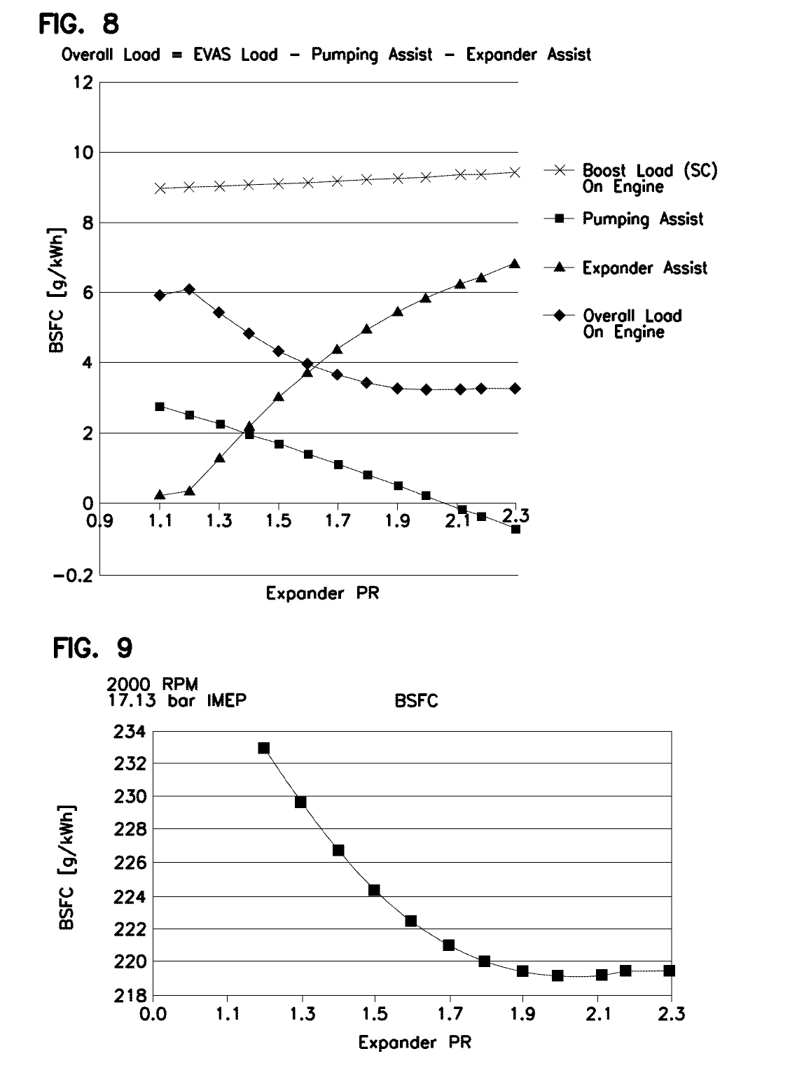

Improved efficiency and higher enthalpy available for extraction as a result of increased backpressure results in higher shaft power from waste heat recovery device. This pattern is seen in FIG. 8 in which power curves are shown for the boost load (supercharger) on the engine, pumping assist, expander (i.e. waste heat recovery device) assist, and overall load on the engine in relation to waste heat recovery device pressure. The expander assist curve shows the expander shaft output power that is transmitted back into the engine, which has the effect of lowering the load on the engine. The pump assist curve shows the load imparted on the engine due to the increased backpressure caused by the operation of the expander. Thus, the backpressure caused by the expander has the effect of increasing the load on the engine (at least up to about a pressure of about 2 bar). The boost load curve shows the load imparted onto the engine due to the operation of the supercharger and is shown as slightly increasing with expander back pressure, but being relatively constant in comparison to the other curves because the indicated torque of the engine remains same. The overall load on engine curve shows the combined load imparted on the engine as a summation or function of the pumping assist, expander assist, and boost load on the engine.

By calculating the overall load on the engine as shown in FIG. 8, a noticeable pattern is revealed that this new quantity follows in which the load drops and then increases. A reduction in ‘Overall Load on Engine’ has a positive effect on Engine efficiency, while the deteriorating combustion efficiency has a negative one. These two effects combined, result in the Engine BSFC (brake specific fuel consumption) pattern shown in FIG. 9.

FIG. 9 shows that the BSFC initially drops to a lower limit and then starts increasing again as a function of back pressure caused by the expander. Thus, the most economic operating point for the system can be identified as the lowest point in the curve. Accordingly, the system will operate at optimum efficiency when the expander is operated to achieve the backpressure corresponding to the lowest point in the curve. In the example shown, this optimal backpressure is between about 1.9 and 2.1 bar, or about 2 bar at the shown operating state of the system when the engine is operating at 2,000 RPM and an indicated mean effective pressure (IMEP) of 17.13.

Based on the aforementioned, the controller can be configured to have a map-based control to achieve the optimal optimizing condition by evaluating system operating parameters to determine the lowest BSFC for current operating conditions and then operating the expander to exert a backpressure on the engine that corresponds to the lowest BSFC. This can be accomplished by evaluating system operating parameters and then referring to one or more maps correlating BSFC with varying engine backpressures applied and by referring to an expander power generation map to establish the optimum backpressure solution for the given driving condition. In one aspect, the algorithm in the controller can always ensure that the power generated by the expander is greater than the impact of the pumping losses on the engine due to the back pressure from the expander.

Other implementations will be apparent to those skilled in the art from consideration of the specification and practice of the examples and teachings presented herein. It is intended that the specification and examples be considered as exemplary only, with the true scope of the invention being indicated by the following claims.

1. A power generation system comprising:
a. a power plant having an air intake and an exhaust outlet;
b. a boost device in fluid communication with the power plant air intake, the boost device being for pressurizing air entering the power plant air intake;
c. a waste heat recovery device in fluid communication with the power plant exhaust outlet, the waste heat recovery device being for recovering energy from exhaust from the power plant;
d. a first motor/generator coupled to the boost device;
e. a second motor/generator coupled to the waste heat recovery device;
f. an energy storage device for storing energy generated by the first and second motor/generators and for delivering power to drive at least one of the first and second motor/generators;
g. a controller for controlling the first and second motor/generators, wherein the controller is configured to control the level of power generated by the waste heat recovery device based on a state of charge of the energy storage device.

2. The power generation system of claim 1, wherein the controller includes a dynamic recovery factor defined as the ratio between the power generated by the waste heat recovery device at the second motor/generator and the power delivered to the first motor/generator to drive the boost device.

3. The power generation system of claim 2, wherein the dynamic recovery factor is set to equal a value of 1 when the state of charge of the energy storage device is at zero.

4. The power generation system of claim 3, wherein the dynamic recovery factor is set to equal a value of 1 when the state of charge of the energy storage device is between zero and a predetermined setpoint.

5. The power generation system of claim 4, wherein the dynamic recovery factor is decreased as the state of charge of the energy storage device increases beyond the predetermined setpoint.

6. The power generation system of claim 1, wherein the boost device is a Roots-type supercharger.

7. The power generation system of claim 6, wherein the boost device is coupled to the first motor/generator with a power transmission link that is also coupled to the power plant.

8. The power generation system of claim 7, wherein the power transmission link is a planetary gear set.

9. The power generation system of claim 1, wherein the waste heat recovery device is a volumetric expander.

10. A power generation system comprising:
a. an internal combustion engine having an air intake and an exhaust outlet;
b. a Roots-type supercharger in fluid communication with the engine air intake, the supercharger being for pressurizing air entering the engine air intake;
c. a volumetric expander in fluid communication with the engine exhaust outlet, the volumetric expander being for recovering energy from exhaust from the internal combustion engine;
d. a first motor/generator coupled to the supercharger;
e. a second motor/generator coupled to the expander;
f. a battery for storing energy generated by the first and second motor/generators and for delivering power to drive the first motor/generator;
g. a controller for controlling the first and second motor/generators, wherein the controller is configured to control the level of power generated by the expander based on a state of charge of the battery.

11. The power generation system of claim 10, wherein the controller includes a dynamic recovery factor defined as the ratio between the power generated by the expander at the second motor/generator and the power delivered to the first motor/generator to drive the supercharger.

12. The power generation system of claim 11, wherein the dynamic recovery factor is set to equal a value of 1 when the state of charge of the battery is at zero.

13. The power generation system of claim 12, wherein the dynamic recovery factor is set to equal a value of 1 when the state of charge of the battery is between zero and a predetermined setpoint.

14. The power generation system of claim 13, wherein the dynamic recovery factor is decreased as the state of charge of the battery increases beyond the predetermined setpoint.

15. The power generation system of claim 11, wherein the dynamic recovery factor is a dynamic function calculated within the controller during operation of the internal combustion engine, and is based on one or more of: backpressure on the engine torque output, driver operating patterns, drive cycle aggressiveness; battery condition, age of the battery, ambient temperature, battery discharging patterns, engine exhaust temperature and composition, engine operating temperature, and throttle position indicating a request for passing/acceleration.

16. The power generation system of claim 10, wherein the boost device is coupled to the first motor/generator with a power transmission link that is also coupled to the internal combustion engine.

17. The power generation system of claim 16, wherein the power transmission link is a planetary gear set.

18. A method for controlling a power generation system including an internal combustion engine, a supercharger, and a volumetric expander, the method comprising:
a. identifying a required first power value for driving a first motor/generator associated with the supercharger;
b. determining a state of charge of a battery connected to the first motor/generator;
c. determining a second power value for a second motor/generator associated with the volumetric expander, the second power value being based on the battery state of charge.

19. The method for controlling a power generation system of claim 18, further including the step of defining a dynamic recovery factor that is the ratio between the second power value and the first power value.

20. The method for controlling a power generation system of claim 19, further including setting the dynamic recovery factor to equal a value of 1 when the state of charge of the battery is between zero and a predetermined setpoint, and further including decreasing the dynamic recovery factor as the state of charge of the battery increases beyond the predetermined setpoint.

21. (canceled)

22. (canceled)

23. (canceled)

24. (canceled)

25. (canceled)
